(19) United States
(12) Patent Application Publication
(10) Pub. No.: US 2026/0138624 A1
(43) Pub. Date: May 21, 2026

(54) Safe State Management for Autonomous Operations

(71) Applicant: Applied Electric Vehicles Ltd, Scoresby (AU)

(72) Inventor: Marc Alexander, Croydon Hills (AU)

(73) Assignee: Applied Electric Vehicles Ltd, Scoresby (AU)

(21) Appl. No.: 18/954,140

(22) Filed: Nov. 20, 2024

(51) Int. Cl. B60W 50/02; B60W 50/035; B60W 60/00

(52) U.S. Cl. CPC B60W 50/0205; B60W 50/035; B60W 60/0015

(57) ABSTRACT

Safe state management for autonomous operations is described. In one or more implementations, a system includes a vehicle network that communicatively couples a plurality of subsystems of an autonomous vehicle, a plurality of edge devices that manage operational states of the subsystems to report health data to the vehicle network indicative of at least one subsystem failure, and a central control unit that manages a global safety state of the autonomous vehicle based on the reported health data and coordinates a predetermined vehicle response across the edge devices to maintain a safe operating envelope of the autonomous vehicle during the subsystem failure.

### BACKGROUND

As technology evolves, vehicles systems are increasingly being deployed with autonomous driving capability. Hardware and software of these systems is highly susceptible to a wide range of potential faults and errors, which significantly impact functionality and safety, especially when driving. Continuously and reliably safeguarding autonomous systems from these potential faults and errors is challenging due to cost and complexity. Ensuring the integrity of these safeguards for ensuring driving safety by autonomous systems is often mandated by law.

### BRIEF DESCRIPTION OF THE DRAWINGS

FIG. 1 is a block diagram of a non-limiting example environment including a vehicle having a whole-vehicle system that implements safe state management for autonomous operations.

FIG. 2 is a block diagram of a non-limiting example of a vehicle system that implements safe state management for autonomous operations.

FIG. 3 is a block diagram of a non-limiting example of a vehicle system that implements safe state management for autonomous operations.

FIG. 4 is a block diagram of a non-limiting example of a vehicle system that implements safe state management for autonomous operations.

FIG. 5 depicts a flow chart of a non-limiting example of a procedure for implementing safe state management for autonomous operations.

### DETAILED DESCRIPTION

Modern vehicle architectures incorporate electronic systems that facilitate various levels of autonomous driving capability. These autonomous systems include multiple electronic control units (ECUs) (also referred to as controllers) that are distributed throughout the vehicle to communicate and control different subsystems. Like other hardware and software systems, ECUs are susceptible to faults and errors, especially in harsh conditions typical of many driving environments. For example, hardware faults occur when an ECU is physically damaged or otherwise rendered inoperable, such as due to harsh weather, rough roads, or impacts. Hardware faults also occur from cases of electronic component failures within the ECUs or electrical systems. Software glitches are errors that cause autonomous vehicles to perform unsafe autonomous operations, e.g., slowed, or improper autonomous maneuvering. Furthermore, software and hardware glitches are caused by external forces such as neutrino radiation striking a sensitive node in a live micro-electronic device, such as in a microprocessor, semiconductor memory, or power transistors. An autonomous driving system relying on an inoperable or malfunctioning controller jeopardizes safety.

In some jurisdictions, specific safeguards for driving autonomously are mandated by vehicle and traffic laws. These traffic laws, for instance, reference vehicle safety standards that define criteria for reducing risks to occupants and pedestrians. Adhering to these standards ensures that self-driving vehicles continuously and reliably operate safely in the presence of humans; passengers, occupants, and pedestrians alike.

The International Organization for Standardization (ISO) publishes ISO standard 26262 titled “Road vehicles – Functional Safety.” This standard outlines safety integrity requirements for various electrical and electronic systems. Automotive Safety Integration Level D (ASIL-D) is the highest level of safety integrity defined by ISO 26262, which assesses the severity and probability of defects causing harm to human life. Achieving ASIL-D compliance for autonomous driving systems involves creating redundant system architectures and safety mechanisms. These solutions enhance system availability and ensure integrity of fail-operational capabilities, even in the presence of faults. The Society of Automotive Engineers (SAE) defines different levels of vehicle autonomy. Achieving SAE Level 4 and Level 5 certifications indicates that an autonomous driving system is capable of performing at the highest level of driving autonomy. For example, achieving SAE Level 4 involves implementing robust perception and decision-making algorithms, redundancy, safe and deterministic behaviour in the event of any fault of any type, and fail-operational motion control mechanisms.

Achieving ASIL-D compliance and SAE Level 4 autonomy is important for self-driving vehicles, especially those operating without support for human intervention. However, complying with ASIL-D and reaching SAE Level 4 autonomy is difficult. Automakers have attempted to achieve various degrees of autonomous safety by addressing hazardous scenarios on a case-by-case basis, with a focus on using vehicle sensors to identify and mitigate each of those hazards separately. This approach attempts to account for more nuanced hazards that involve a combination of already mitigated hazards, which results in ever increasing complexity. Even so, implementing reliable vehicle safeguards, which ensure autonomous operations continue despite a wide range of potential ECU faults and errors, is challenging. Existing approaches to managing operational safety of autonomous vehicles are inadequate to meet safety requirements of autonomous vehicle standards, especially in complex driving environments.

In accordance with techniques of this disclosure, safe state management for autonomous operations is described. The techniques enable fully autonomous vehicles to maintain a safe operating state, continuously and deterministically, despite an occurrence of ECU faults or errors. Safe state management for autonomous operations, for instance, enables a control system of an autonomous vehicle to provide maximum control authority to autonomous operations that are executed across various edge devices such that a safe operating envelope within a motion boundary is maintained during a subsystem failure.

In at least one implementation, a whole-vehicle system of an autonomous vehicle includes a vehicle network that communicatively couples a plurality of subsystems, which are distributed throughout the vehicle. A plurality of edge devices (e.g., various ECUs and controllers) within the autonomous vehicle are used to manage operational states of these subsystems. Examples of the edge devices include a motor controller, a steering unit, a braking actuator, and the like. The operational states of the subsystems are managed, at least in part, through the reporting of health data to the vehicle network. The health data conveys the absence or presence of faults and errors reported from the edge devices. For example, when a subsystem is operating as intended, a controlling edge device reports health data to the vehicle network that indicates there are no errors or failures. When a problem arises at the subsystem (e.g., hardware fault, software glitch), the edge device outputs health data indicative of a subsystem failure (e.g., an error condition that diminishes performance of a vehicle function). Based on the reported health data, a central control unit of the autonomous vehicle is then operable to manage a global safety state of the whole-vehicle system. This includes ingesting all faults - internal and external being reported from the edge devices or within the central control unit itself. The central control unit resolves each of the faults into an observable, considered, and deterministic outcome that delivers maximum motion control authority at all times, in all single and multi-point fault conditions.

The global safety state corresponds to a whole-health operating condition of the autonomous vehicle, which represents the integrity and reliability of autonomy implemented by the edge devices and subsystems. A warning safety state, a minor safety state, a major safety state, and a critical safety state are example global safety states of the whole-vehicle system. Based on the health data collected from each of the edge devices, the central control unit derives the global safety state to determine whether continuing to enable autonomous functions of the autonomous vehicle is safe, reliable, and not a risk to safety, overall.

In one or more aspects, the central control unit implements a safe state manager that uses a finite state machine to derive the global safety state based on the reported health data. The safe state manager represents a software module, for instance, which executes on hardware of the central control unit to deliver maximum control authority over the system. When implemented in software, the safe state manager is a single software module executing independently among a plurality of other software modules that have responsibility for controlling the subsystems that perform various functions of the vehicle. As a stand-alone module executing within the central control unit, the safe state manager is more easily inspectable for auditing and certifying its safety than if intertwined among other software modules that manage vehicle functions. In at least one other example, the safe state manager is implemented in a standalone hardware block of the central control unit, or as a combination of software and hardware.

Based on the global safety state derived from the health data, the safe state manager coordinates a predetermined vehicle response across the edge devices to maintain a safe operating envelope of the autonomous vehicle, including during the subsystem failure. By definition, the safe operating envelope defines a motion based boundary of the autonomous vehicle, which is not be exceeded no matter the occurrence of any fault(s) or failure(s). This deterministic, nested state machine has an entry point for each possible fault or error that may occur within each of the subsystems. The state machine accounts for a total health of the vehicle and its safe motion capability in real-time to determine a safe operating state given the faults and errors being reported. The safe state manager relies on the state machine to efficiently arbitrate driving decisions and force the central control unit into the safest operating state with the highest operating precision and motion capability, no matter the driving conditions or impacted subsystems.

The safe state manager allows emergency fault and error mitigation to occur locally within an impacted subsystem. However, at the same time local mitigation is attempted, the safe state manager is operable to develop a whole-system mitigation and potentially transition the central control unit into a different, safe operating state. For example, after being notified by the impacted ECU, or determining that internal hardware, control, or software elements within the central control unit itself are impacted, the safe state manager configures the central control unit to quickly propagate a predetermined, system-wide response. In one or more examples, this system-wide response bolsters or overrides a local mitigation attempt. The central control unit commands the whole-vehicle system to enter the safest operating state by invoking, at each subsystem, autonomous operations that prioritize vehicle safety. Implementation of this centralized, safe state manager enables the autonomous vehicle to have an auditable (e.g., observable, and deterministic) solution for achieving ASIL-D compliance at the total vehicle level, with SAE Level 4 automation certification, no matter the driving situation.

Although the ISO and SAE standards are discussed throughout this disclosure with reference to ASIL-D and Level 4 autonomy certifications, compliance achieved by implementing safe state management of autonomous operations is not limited to these two standards. By way of example, it is to be appreciated that compliance with other vehicle safety standards, alone or in combination with the ISO and SAE standards, is achievable by performing safe state management of autonomous operations in accordance with the described techniques.

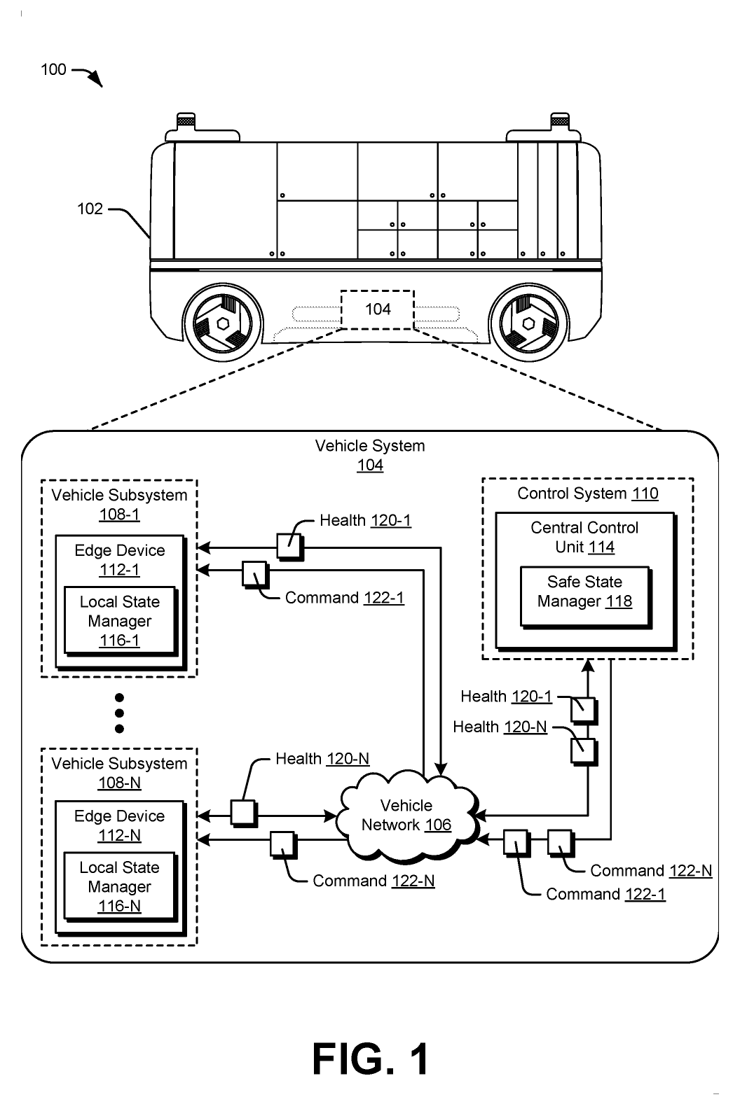

FIG. 1 is a block diagram of a non-limiting example environment 100 including a vehicle 102 having a whole-vehicle system 104 that implements safe state management for autonomous operations. The environment 100 includes any type of vehicle operating environment, such as a roadway, a traffic scenario, an off road area (e.g., a construction site, a mining operation, a recreational area), in the air, on or in the water, on or in other substances (e.g., within fluids and/or cellular material), in space, and other public or private spaces, to name a few. The vehicle 102 depicted in the environment 100 may be any type of autonomous vehicle including ground vehicles (e.g., trucks, cars, vans, tractor-trailers, tanks), air vehicles, rail vehicles, marine vehicles, space vehicles, or other vehicle types.

The vehicle 102 includes a vehicle system 104, which generally includes multiple electronic subsystems configured to interface with electro-mechanical components of the vehicle 102. The vehicle system 104 is configured to implement processor-based vehicle functions and processor-driven operations, such as for autonomously driving or maneuvering the vehicle 102 in the environment 100. Also referred to as a “whole-vehicle system,” the vehicle system 104 includes a vehicle network 106 that communicatively couples a plurality of vehicle subsystems 108 to each other as well as to a control system 110 of the vehicle 102. As labeled in FIG. 1, the vehicle subsystems 108 are distributed on the vehicle 102 as a vehicle subsystem 108-1 through a vehicle subsystem 108-N, where N is any integer. The vehicle subsystems 108 each include one or more edge devices 112. For example, the vehicle subsystem 108-1 includes an edge device 112-1, and the vehicle subsystem 108-N includes an edge device 112-N.

The vehicle subsystems 108 are locally managed by the edge devices 112, which are connected to the vehicle network 106. The edge devices 112 manage the subsystems 108 by communicating with each other and the control system 110 over the vehicle network 106. Based on the network communication, the control system 110 issues commands to the edge devices 112 that are distributed throughout the vehicle 102 to execute vehicle operations that control, in a coordinated fashion, these otherwise disparate actors of the various subsystems 108. For example, a central control unit 114 of the control system 110 centrally manages the edge devices 112 to maintain a safe operating envelope of the vehicle 102 as the subsystems 108 are controlled to enforce autonomous driving functionality appropriate for a given safety state.

The vehicle network 106 is implemented as a wireless or wired network for communicating vehicle data throughout the vehicle system 104. For example, each of the vehicle subsystems 108 and the central control unit 114 share interfaces (e.g., connections) to the vehicle network 106 for exchanging data (e.g., health data, operating data, signals, commands) throughout the vehicle 102. The edge devices 112 and the central control unit 114, for instance, each include a network interface adapter (not shown) that is operable to transmit and receive data via the vehicle network 106. Various types of connections between the vehicle network 106 and the components of the vehicle system 104 are usable on the vehicle 102, such as wired connections including, but not limited to, Ethernet connections or links, memory channels, buses (e.g., a data bus, a system or address bus, a controller area network or CAN bus), interconnects, through silicon vias, traces, pins and sockets, and planes, to name just a few. Other example connections include optical connections, fiber optic connections, and/or connections or links based on quantum entanglement.

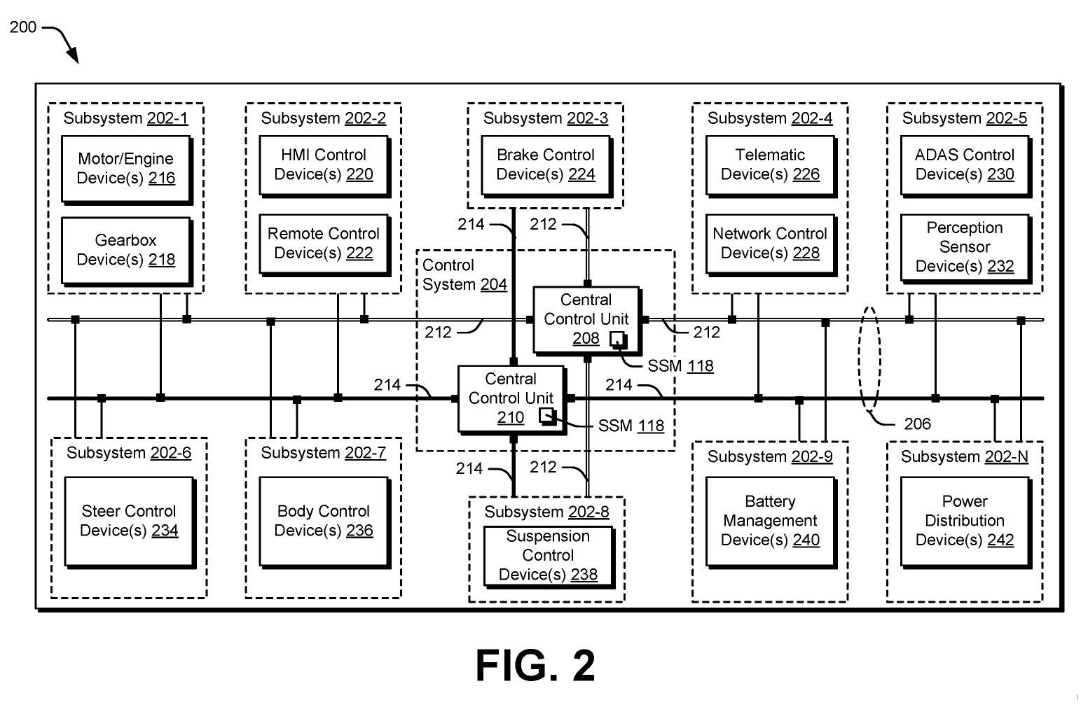

Numerous examples of the vehicle subsystems 108 exist, including but not limited to a propulsion or motion subsystem (e.g., providing motion control), a drive subsystem such as an advanced driving and safety subsystem (ADAS) (e.g., providing autonomous or semi-autonomous motion control), a braking subsystem (e.g., providing brake control), an electronic stability control (ECM) subsystem, and a communication subsystem for handling on-board and/or offboard communications (e.g., data and telemetry, vehicle-to-vehicle, vehicle-to-everything, cellular, Bluetooth), to name just a few. The subsystems 108 represent any other electronic based vehicle component, actuator, machine, or subsystem that is controllable by the central control unit 114 of the control system 110. Further examples of the vehicle subsystems 108 are illustrated in FIG. 2 as subsystems 202. The subsystems 108 and the edge devices 112 may be internal or external to the control system 110. In at least one aspect, the control system 110 includes one or more of the subsystems 108 within an enclosure or contained on an assembly of the control system 110. For example, the control system 110 includes a low voltage power distribution unit as an internal edge device that controls and maintains the integrity of low-voltage or system power connections to edge devices of the vehicle subsystems 108.

The edge devices 112, which are also referred to as ECUs or controllers, manage operational states of the subsystems 108 and implement vehicle functions based on commands received from the control system 110. In one or more implementations, the control system 110 includes one or more of the edge devices 112. For example, the edge devices 112 include an on-board I/O expander of the central control unit 114, a component on a same system on chip as the central control unit 114, or other variation of the central control unit 114 that incorporates one or more of the edge devices 112 on a same assembly or within a same enclosure as the central control unit 114. In one or more aspects, at least one of the edge devices 112 is internal to the central control unit 114 and operable to provide I/O control signals to the central control unit 114 to maintain a safe operating envelope of the vehicle 102.

The control system 110 and the central control unit 114 are physically located centrally on the vehicle 102 relative the edge devices 112 and the vehicle subsystems 108, in at least one implementation. In one or more implementations, the control system 110 and the central control unit 114 are logically or functionally located central to the vehicle 102. For example, the central control unit 114 is physically closer to one or more of the edge devices 112 and the subsystems 108 than others, while functionally operable to provide centralized command authority over the edge devices 112 and the subsystems 108.

The subsystems 108 and the control system 110 are susceptible to failures (e.g., faults and errors) occurring while the vehicle 102 is driving. These faults and errors occur because of harsh driving environments, vehicle wear, part failure, software error, or other reasons. A fault or error detected at the control system 110, and which is allowed to propagate into the vehicle network 106 as an incorrect signal or command to one or more of the edge devices 112, may cause incorrect vehicle operations that present a risk to safety.

To reliably control the edge devices 112 and the subsystems 108 in a safe way, even in the presence of faults and errors, the central control unit 114 is configured to manage a global safety state of the vehicle 102. For example, the central control unit 114 represents at least one processor of the control system 110 that is configured to issue commands to the edge devices 112. The central control unit 114 issues these commands to implement vehicle functions that mitigate a subsystem fault, error, or failure, including to control vehicle operations for maintaining a safe operating envelope when the vehicle 102 is autonomously driving in the environment 100. In one or more implementations, the central control unit 114 includes multiple instances of redundant hardware and software technology. For example, the central control unit 114 represents multiple (e.g., dual) central control units each implemented using identical processor technology or different processor technology, or hardware and software configurations that implement redundant functionality. In the event of a failure of one instance of the central control unit 114, another instance of the central control unit 114 is operable to command the subsystem 108 and the edge devices 112 to force the vehicle 102 into a safe operating state. As described below, the central control unit 114 implements a safe state manager 118 that configures the central control unit 114 to ingest a fault or combination of faults from any source and of any kind. The central control unit 114 mitigates each fault by solving for a lowest safety state outcome after one or more mitigation actions are performed by the safe state manager 118.

In at least one example, one or more processors of the central control unit 114 are electronic circuits that process instructions for executing control routines on the vehicle 102. Processor execution of the control routines enables the central control unit 114 to manage vehicle operations implemented by the edge devices 112 for causing smooth and safe driving by the vehicle 102. Each of the edge devices 112 likewise includes one or more processors, which are electronic circuits that process instructions for executing subsystem functions on the vehicle 102. Processor execution of the subsystem functions enables the edge devices 112 to implement vehicle operations managed by the central control unit 114 for achieving smooth and safe autonomous driving by the vehicle 102.

Examples of the processors of the central control unit 114 and/or the edge devices 112 include but are not limited to a central processing unit (CPU), a graphics processing unit (GPU), a field programmable gate array (FPGA), an accelerator, an accelerated processing unit (APU), and a system on chip (SoC), a microcontroller, an electronic control unit (ECU), a digital signal processor (DSP), and an infrastructure processing unit (IPU) to name a few. In one or more variations, the processors of the central control unit 114 and/or the edge devices 112 include multiple co-processors, multiple cores (e.g., a multi-core processor). In one or more other variations, the processors of the central control unit 114 and/or the edge devices 112 include one core (e.g., a single processor core).

The central control unit 114 and/or the edge devices 112 further include a memory or other computer-readable storage media that stores instructions for execution by the processors to redundantly control the vehicle operations or implement vehicle functions in furtherance of the vehicle operations. For example, the central control unit 114 and/or the edge devices 112 each include a memory circuit that stores instructions and data for executing a program (e.g., software, firmware). In one or more implementations, the memory corresponds to semiconductor memory where data is stored within memory cells on one or more integrated circuits. In one or more variations, the data is stored on a disk, a storage array, or other non-transitory computer-readable medium. The data includes information stored or accessed by each of the central control unit 114 and/or the edge devices 112, such as for generating outputs commands and signals to the vehicle network 106.

In at least one example, a memory of the central control unit 114 and/or the edge devices 112 corresponds to or includes volatile memory, examples of which include random-access memory (RAM), dynamic random-access memory (DRAM), synchronous dynamic random-access memory (SDRAM), static random-access memory (SRAM), and memristors. The memory of each of the central control unit 114 and/or the edge devices 112 is configurable with any number of memory (e.g., physical memory) without departing from the spirit or scope of the described techniques. Alternatively or in addition, the memory of each of the central control unit 114 and/or the edge devices 112 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). Further examples of memory configurations include low-power double data rate (LPDDR), also known as LPDDR SDRAM. The memory of each of the central control unit 114 and/or the edge devices 112 is configurable in a variety of ways capable of supporting autonomous vehicle controls.

The edge devices 112 are configured to locally manage operational states of the subsystems 108, including to report health data to the vehicle network 106 indicative of presence or absence of subsystem failures. The edge devices 112 output health data 120 to the central control unit 114 and ingest the health data from the central control unit 114 as a way to report a local operational state of one or more of the subsystems 108 managed by the edge devices 112, as well as to self-arbitrate between being controlled by a healthy instance of the central control unit 114 (e.g., when an unhealthy instance of the central control unit 114 reports a problem in its health data 120). In one or more examples, the central control unit 114 includes redundant control units that self-report the health data from the central control unit 114 and to the edge devices 112. This enables the edge devices 112 to self-arbitrate which instance of the central control unit 114 to rely on for responding to signals and commands. For example, the edge devices 112 (e.g., motor control units, traction battery units, steering control units) each implement local state managers 116 each configured to perform fault observation, detection, and reaction within its local domain of control and safety, as well as its external domain (e.g., to observe and self-arbitrate based on the health data 120 received from the central control unit 114). The local state managers 116 of the edge devices 112 attempt to rapidly mitigate local faults at corresponding subsystems 108, which are within a domain and authority of control and safety for that subsystem 108. In addition to attempting to mitigate local faults, the local state managers 116 enable the edge devices 112 to immediately report health data indicative of an operational state, and in some cases, report a subsystem failure to the central control unit 114. To avoid control authority issues and forward-function prediction issues, the edge devices 112 in one or more implementations act in an atomic nature to commands from the central control unit 114. Based on the health data 120 injected from the central control unit 114, the local state managers 116 self-arbitrate between redundant control circuits or control routines executing within the central control unit 114. For example, the central control unit 114 includes multiple redundant control units 114, and the edge devices 112 select one of the redundant control units 114 that reports a healthiest state. Said differently, the local state managers 116 stop taking commands from an unhealthy instance of the central control unit 114 when the health data received indicates a problem with its control authority. The local state managers 116 switch to being controlled based on commands from the healthiest instance of the central control unit 114 to ensure the vehicle 102 is maintaining a safe operating envelope.

The central control unit 114 is configured to manage a global safety state of the vehicle 102 based on the reported health data and coordinate a predetermined vehicle response across the edge devices 112 to maintain a safe operating envelope of the vehicle 102 during the subsystem failure. To achieve whole-vehicle, functional and motion based safety with a range of disparate actors in the system 104 (e.g., the edge devices 112), the central control unit 114 implements the safe state manager 118. Rather than mitigate unsafe conditions locally within each of the edge devices 112 of the system 104, the safe state manager 118 forces the vehicle 102 into a safe operating state that invokes vehicle operations performed at the edge devices 112, which ensure safety across the system 104. The safe state manager 118, for instance, ingests health data 120 (e.g., fault, error, warning, state, etc.) being reported to the central control unit 114 from the local state managers 116 of each of the edge devices 112, as well as heath data 120 reported in the other direction (e.g., from the central control unit 114 to the local state managers 116 of the edge devices 112). The safe state manager 118 ingests a fault or combination of faults based on the health data 120 from any source and of any kind and mitigates each fault by solving for a lowest safety state outcome after one or more mitigation actions are performed.

The safe state manager 118 receives the health data 120 being reported to the vehicle network 116, almost instantaneously when a failure is detected. For example, the central control unit 114 executes a safe state manager 118 that is configured to collect the health data 120 and other information reported to the network 106 from the edge devices 112 and/or from the central control unit 114 itself. The health data 120 collected from the vehicle network 106 is used by the safe state manager 118 to map the local operational states of the edge devices 112 to the safest operational state of the vehicle system 104.

The safe state manager 118 is implemented to provide a deterministic, observable, and programmatic entry point for each possible health condition of the vehicle system 104. The safe state manager 118 forces the vehicle system 104 into the safest operating state of the vehicle’s motion integrity and capability and may also trigger a transition in operational mode or function of the vehicle 102 for maintaining a safe operating envelope. In at least one example, the safe state manager 118 is a single actor (e.g., a single software module) that aggregates the health data 120 received from the vehicle network 106 to derive a whole-health condition of the vehicle system 104. This enables the safe state manager 118 to be auditable from a functional safety perspective (e.g., for complying with ASIL-D and/or achieving Level 4 autonomy).

The safe state manager 118 of the central control unit 114 is responsible for the management of the safe state of the safe operating envelope of the vehicle 102. The safe state manager 118 removes ability of the distributed edge devices 112 in the vehicle system 104 from independently deciding a whole system behavior based on individual health assessments received from the local state managers 116. This enables the safe state manager 118 to globally manage a safe operating envelope of the vehicle 102. A safe operating envelope, for instance, causes the vehicle 102 to remain within a small distance threshold (e.g., plus or minus two inches) of a current location in physical space intended for the vehicle 102 in the environment 100, despite any faults or errors. The safe state manager 118 deterministically and objectively solves an error or fault problem for the vehicle system 104, to cause the vehicle 102 to remain in a safe operating envelope. The safe state manager 118 allows for the safe and complete removal of reliance on human or remote intervention, especially during multi-point failures among the subsystem 108.

A function of the safe state manager 118 is to be directly responsible for the continuous management of the vehicle 102 to operate at the safest state available, including to provide a maximum available control authority to an autonomous driving function, and implement a safe navigation path. The safe state manager 118 provides a single, trusted, and structured location for fault monitoring, system status observation and reaction. Based on the health data 120 and/or other communications received from the local state managers 116, the safe state manager 118 is aware of subsystem failures and manages a safe vehicle state across each of the subsystems 108.

The safe state manager 118 is configured to provide executive level or global level of management of the vehicle system 104 for operating in a safe state. In one or more implementations, the safe state manager 118 includes a finite state machine that provides entry points for each potential fault and status condition that may be reported from the local state managers 116. The finite state machine configures the safe state manager 118 to react to health data reported from the edge devices 112 with a predetermined or “deterministic” response. For example, the finite state machine of the safe state manager 118 represents deterministic executable code (e.g., software) that is reviewable for auditing against compliance with a standard, including for compliance in the presence of any fault or combination of faults.

To illustrate how the central control unit 114 manages the global safety state of the vehicle 102 for maintaining a safe operating envelope during a failure at one or more of the subsystems 108, consider a scenario where the vehicle 102 is autonomously driving in traffic. As the vehicle 102 is driving, the edge devices 112 manage an operational state of the subsystems 108. Examples of the operational states reported from the subsystems 108 include a normal operational state, a diminished operational state, and a failed operational state. For example, the local state manager 116-1 manages an operational state of the subsystem 108-1 and the local state manager 116-N manages an operational state of the subsystem 108-N. The health data 120 reported from the edge devices 112 indicates the operational state of a corresponding one of the subsystems 108 and an indication of any failures. For example, the local state manager 116-1 outputs health data 120-1 to the vehicle network 106 including an indication of an operational state of the subsystem 108-1, while the local state manager 116-N outputs health data 120-N to the vehicle network 106 including an indication of an operational state of the subsystem 108-N.

In at least one aspect, when the subsystems 108 are in a normal operational state, the subsystems 108 implement vehicle functions with expected behavior. In contrast, when the subsystems 108 are in a diminished operational state, the subsystems 108 experience as least one warning condition or minor failure that inhibits some of the vehicle functions performed by those subsystems 108. The diminished operational state causes diminished behavior of the subsystems 108 but does not necessarily prevent the control system 110 and the central control unit 114 from maintaining a safe operating envelope of the vehicle 102. When the subsystems 108 are in a failed operational state, the subsystems 108 experience at least one major or critical failure that inhibits a majority of the vehicle functions performed by those subsystems 108. The failed operational state causes diminished behavior of the subsystems 108, which prevents the control system 110 and the central control unit 114 from maintaining a safe operating envelope of the vehicle 102.

As the vehicle 102 is driving, and the local state managers 116 are managing the operational states of the subsystems 108, the central control unit 114 executes the safe state manager 118 to manage a global safety state of the vehicle 102. Examples of the global safety state of the vehicle 102 include a warning safety state, a minor safety state, a major safety state, and a critical safety state. The safe state manager 118 manages the global safety state of the vehicle 102 based on the health data 120 reported from the local state managers 116. For example, the safe state manager 118 receives the health data 120-1 and the health data 120-N from the vehicle network 106 including indications of the operational states of the subsystems 108-1 and 108-N, respectively.

In at least one implementation, when the safe state manager 118 forces the vehicle 102 into the warning safety state, the health data 120 reported from the local state managers 116 indicates one or more of the subsystems 108 is operating in the diminished operational state and experiencing an undefined failure. The undefined failure causes the vehicle system 104 to have some diminished capability but is not severe enough to prevent the central control unit 114 from maintaining a safe operating envelope of the vehicle 102. However, when subsequent failures appear in the health data 120 reported as the vehicle 102 is in the warning safety state, the safe state manager 118 immediately raises the global safety state of the vehicle 102 to the critical safety state.

In one or more examples, when the safe state manager 118 forces the vehicle 102 into the minor safety state, the health data 120 reported from the local state managers 116 indicates one or more of the subsystems 108 is operating in the diminished operational state and experiencing a minor failure. The minor failure causes the effected subsystems 108 to operate in a diminished capacity, which does not prevent the central control unit 114 from maintaining of a safe operating envelope of the vehicle 102.

In at least one aspect, when the safe state manager 118 forces the vehicle 102 into the major safety state, the health data 120 reported from the local state managers 116 indicates one or more of the subsystems 108 is operating in the failed operational state and experiencing a major failure. The major failure causes the effected subsystems 108 to operate in a failed operational state, which prevents the central control unit 114 from maintaining a safe operating envelope of the vehicle 102.

In one or more implementations, when the safe state manager 118 forces the vehicle 102 into the critical safety state, the health data 120 reported from the local state managers 116 indicates one or more of the subsystems 108 is operating in the failed operational state and experiencing a critical failure. The critical failure causes the effected subsystems 108 to operate in a failed operational state, which prevents the central control unit 114 from maintaining a safe operating envelope of the vehicle 102 and leads to execution of an emergency vehicle function. For example, when safety of occupants, pedestrians, or other vehicles is at risk, the safe state manager 118 executes a predetermined response across the edge devices 112 to implement an emergency stop.

Recall the example described above, where the vehicle 102 is driving in traffic and the local state manager 116-1 and the local state manager 116-N are outputting the health data 120-1 and the health data 120-N, respectively, to the vehicle network 106. The safe state manager 118 receives the health data 120-1 and the health data 120-N from the vehicle network 106. Based on the health data 120-1, the safe state manager 118 determines the operational state of the subsystem 108-1 to be a normal operational state. In contrast, and based on the health data 120-N, the safe state manager 118 determines the operational state of the subsystem 108-N to be a failed operational state.

The safe sate manager 118 derives the global safety state of the vehicle 102 based on a combination of the operational states reported from the local state manager 116-1 and the local state manager 116-N. For example, with the subsystem 108-N in the failed operational state, the safe state manager 118 determines that the safe operating envelope of the vehicle 102 is untenable even though the operational state of the subsystem 108-1 is a normal operational state. In one or more examples, the safe state manager 118 transitions the vehicle 102 into a major safety state in response to arriving at a predetermined mitigation that compensates for the failed operational state of the subsystem 108-N.

For example, if the subsystem 108-N is a redundant steering subsystem that has failed, while the subsystem 108-1 is a steering system that is able to implement steering functions independently, the safe state manager 118 transitions the vehicle 102 into a major safety state because redundant steering controls may ensure reliable vehicle control. In transitioning the vehicle 102 into the major safety state, the safe state manager 118 communicates with other software modules executing at the central control unit 114 and/or with one or more of the edge devices 112 by issuing commands 122-1 and 122-N that cause the subsystem 108-1 and the subsystem 108-N to perform predetermined atomic operations that preserve the safe operating envelope of the vehicle 102. Executing the atomic operations, for instance, causes the vehicle 102 to safely exit from traffic and arrive at a controlled stop in a parking spot or shoulder of a roadway.

In another example, if the subsystem 108-N is a regenerative charging subsystem that has failed, while the subsystem 108-1 is a battery management system that is able to continue to supply electrical power to propel the vehicle 102, the safe state manager 118 transitions the vehicle 102 into a minor safety state because the battery management system still supports safe and reliable vehicle control for several minutes or hours of driving. In transitioning the vehicle 102 into the minor safety state, the safe state manager 118 allows the subsystem 108-N to attempt to self-mitigate the failure. If based on subsequent health data 120-N, the battery regenerative charging subsystem failure is not self-mitigated within a time threshold (e.g., within one second, within one minute, within one hour), the safe state manager 118 issues commands 122-1 and 122-N to the subsystems 108 to perform predetermined mitigation routines. The safe state manager 118 communicates with other software modules executing at the central control unit 114 and/or with one or more of the edge devices 112 to perform predetermined atomic operations that preserve the safe operating envelope by causing the vehicle 102 to safely exit from traffic and arrive at a controlled stop in a parking spot or shoulder.

In the above example, if the health data 120-1 indicates the subsystem 108-1 (e.g., the battery management system) is in a failed operational state and the health data 120-N indicates the subsystem 108-N (e.g., the regenerative charging subsystem) is in a normal operational state, the safe state manager 118 transitions the vehicle 102 immediately into a critical safety state because the battery management system helps ensure safe and reliable vehicle control while the regenerative braking subsystem is not. The safe state manager 118 does not wait for the subsystem 108-1 to self-mitigate the problem and instead, issues commands 122 to the subsystems 108 to perform predetermined atomic operations that induce an emergency vehicle function. For example, the vehicle 102 issues the commands 122-1 and 122-N to immediately control the brakes on the vehicle 102 and bring the vehicle 102 to an immediate stop, even if traffic is disrupted, to preserve safety of occupants, pedestrians, and other vehicles when the battery management system has failed and is offline.

FIG. 2 is a block diagram of a non-limiting example of a vehicle system that implements safe state management for autonomous operations. For ease of description, the vehicle system 200 is described in the context of the environment 100 shown in FIG. 1 including with reference to similar labeled elements. For example, the vehicle system 200 is a more-detailed version of the vehicle system 104 installed in the vehicle 102. The vehicle system 200 includes a plurality of subsystems 202 (labeled individually as subsystem 202-1 through subsystem 202-N, where N is any integer) that are managed by a control system 204 to implement various vehicle functions. In at least one example, the vehicle system 200 includes additional or fewer subsystems 202 than those depicted in FIG. 2.

The control system 204 is an example of the control system 110 depicted in FIG. 1. The control system 204 is configured as a central control unit that enables information to transfer between the subsystems 202 over a network 206 (e.g., a vehicle network such as the vehicle network 106). By exchanging information with the subsystems 202, the control system 204 causes the subsystems 202 to execute subsystem functions that enable driving. For instance, the control system 204 outputs or receives health signals (e.g., the health data 120-1 and the health data 120-N) communicated on the network 206 to or from one of the subsystems 202, and based on information inferred from the signals, the control system 204 outputs additional signals (e.g., the command 122-1 and the command 122-N) on the network 206 to cause a particular behavior of another of the subsystems 202.

The control system 204 includes a central control unit 208 and a central control unit 210. The central control unit 208 and the central control unit 210 represent separate processors, processor cores, control units, microcontrollers, system on chips, or other processor technology. Each of the central control unit 208 and the central control unit 210 are configured to execute instructions either as software or firmware to implement functionality of the control system 204. In some examples, the control system 204 includes a non-transitory computer-readable storage medium (e.g., data store, cache, static memory, dynamic memory, flash memory, disk storage) that maintains the instructions and data for implementing the instructions executed by each of the central control unit 208 and the central control unit 210. For example, the central control unit 208 and the central control unit 210 include respective data stores that contain the instructions retrieved from the data stores and executed during operation of the vehicle 102. As depicted in FIG. 2, the instructions executed by the central control unit 208 and the central control unit 210 include instructions for implementing redundant versions of the safe state manager 118.

In another implementation, the control system 204 is distributed throughout the vehicle system 200 in two or more locations. In such a distributed implementation, the central control unit 208 is included in a first part of the control system 204 arranged at one part of the vehicle 102 (e.g., a front portion) and the central control unit 210 is included in a second part of the control system 204 positioned at another part of the vehicle 102 (e.g., a rear portion). In other distributed implementations, each part of the control system 204 includes one or more multiple instances of the central control unit 208 and/or the central control unit 210.

In one or more examples, the central control unit 208 and the central control unit 210 are functionally redundant. For example, the processors of each of the central control unit 208 and the central control unit 210 are operable to concurrently receive a same set of inputs from the subsystems 202 (e.g., the edge devices 112 of the vehicle subsystems 108) and concurrently send a same set of outputs to the subsystems 202 (e.g., the edge devices 112 of the vehicle subsystems 108). In a similar way, the processors of each of the central control unit 208 and the central control unit 210 are operable to concurrently receive the same set of inputs from the subsystems 202 (e.g., the edge devices 112 of the vehicle subsystems 108) and concurrently send the same set of outputs to the subsystems 202 (e.g., the edge devices 112 of the vehicle subsystems 108) regardless of whether that processor is the healthiest processor. As described above, the vehicle 102 is configured to distribute health data and enable local arbitration based on the health data (e.g., implementing hot standby) among the various edge devices. The edge devices (e.g., the subsystems 202) continuously consume the control signals and health data of the control system 204, including health data from each of the central control unit 208 and the central control unit 210. Based on the health data 120 communicated through the vehicle network 106, the edge devices synchronously, and seamlessly move to be controlled by the healthier of the multiple control units of the control system 204. For example, based on the health data 120 reported from the central control unit 208 and the central control unit 210, the local state managers 116 self-arbitrate between being controlled by the healthiest of the two central control units 208 and 210. The local state managers 116 stop taking commands from an unhealthy central control unit 208 when the health data received indicates a problem with its control authority. The local state managers 116 switch to being controlled based on commands from a healthy central control unit 210 to ensure the vehicle 102 is maintaining a safe operating envelope.

The subsystems 202 of the vehicle system 200 are examples of the subsystems 108 including the edge devices 112 and the local state managers 116. Each of the subsystems 202 relies on equivalent control operations of either the central control unit 208 or the central control unit 210 (e.g., one at a time) to actively cause vehicle operations or vehicle functions to be performed by the subsystems 202. For example, while the central control unit 208 is orchestrating operations of the subsystems 202, the central control unit 210 is maintained in a ready, standby state. If the central control unit 208 fails, then the control system 204 activates the central control unit 210 to take over and manage the subsystems 202 where the central control unit 208 left off. When the central control unit 210 takes over, the vehicle 102 may be forced to operate in a major safe state or critical safe state, which can include maneuvering away from other vehicles, objects, and pedestrians to come to a controlled stop. The subsystems 202 rely on their local state managers 116 to process health data received from the central control units 208 and 210 to self-arbitrate between being controlled by one or the other (e.g., the healthiest of the central control units 208 and 210). This way, the functional redundancy implemented by the central control unit 208 and the central control unit 210 help the control system 204 to satisfy the ASIL-D requirements for reliability and safety. In such implementations, the central control unit 208 and the central control unit 210 may be located at different locations within the vehicle.

The network 206 is an example of the vehicle network 106, and represents any suitable vehicle network technology, including wired and wireless signal propagation mediums. The network 206 enables real-time data exchange, safety enhancements, and efficient traffic management among the components of the vehicle system 200. The network 206 can include various switches, routers, transceivers, controllers, chokes, filters, terminations, and other networking equipment beyond transmission lines, cables, wires, busses, and other signal routing technologies. In an aspect, the network 206 adheres to an in-vehicle networking protocol. For example, the network 206 represents a combination of one or more of a controller area network (CAN), an automotive ethernet network (AEN), serializer/deserializer (SerDes) network, local interconnect network (LIN), or a FlexRay network (FRN).

In at least one example, to implement the redundancy of the control system 204, the network 206 is composed of dual physical network paths or network channels. In at least one example, the central control unit 208 and the central control unit 210 are operable to concurrently exchange a same set of inputs and outputs with the subsystems 202 (e.g., the edge devices 112 of the vehicle subsystems 108) over different and/or same respective channels (e.g., logical or physical channels) of the network 206 that link the subsystems 202 (e.g., the edge devices 112 of the vehicle subsystems 108) to that central control unit (e.g., processor). A network channel 212 or network path communicatively couples each of the subsystems 202 to the central control unit 208. A separate network channel 214 or network path communicatively links each of the subsystems 202 to the central control unit 210. For example, the network channel 212 is utilized by the central control unit 208 to exchange data over the network 206, and the network channel 214 is utilized by the central control unit 210 to exchange data over the network 206. In at least one implementation, if a failure at the central control units 208 is at least partially caused by a fault in the network channel 212, the central control unit 210 is unaffected by the network fault and operable to communicate with the subsystems 202 using the network channel 214. The functional redundancy implemented by the network channel 212 and the network channel 214 further helps the control system 204 to satisfy the ASIL-D requirements for reliability and safety.

In at least one other example, to implement the redundancy of the control system 204, the network 206 is composed of dual logical network paths or channels. The network channel 212 and the network channel 214 may be separate logical paths through the network 206 that communicatively link each of the subsystems 202 to the central control unit 208 and the central control unit 210 using the same physical wires. In at least one example, the central control unit 208 and the central control unit 210 are operable to interleave a same set of inputs and outputs concurrently exchanged with the subsystems 202 (e.g., the edge devices 112 of the vehicle subsystems 108) over a same set of channels (e.g., logical or physical channels) of the network 206 that link the subsystems 202 (e.g., the edge devices 112 of the vehicle subsystems 108) to that central control unit (e.g., processor). For example, communications to and from the central control unit 208 and the central control unit 210 are interleaved on a single set of wires that make up the network 206. If a failure at the central control unit 210 and/or the network channel 214 occurs, communications from the central control unit 208 can reach the subsystems 202 using the network channel 212. The functional redundancy implemented by interleaving the network channel 212 and the network channel 214 further helps the control system 204 to satisfy the ASIL-D requirements for reliability and safety.

The subsystems 202 are each examples of the vehicle subsystems 108, and include one or more edge devices (e.g., the edge devices 112) operatively coupled to the network 206 to provide information to the control system 204 and receive commands from the control system 204 to implement various vehicle functions. For example, each of the subsystems 202 can include one or more actuators, microcontrollers, machines, or other equipment to perform specific vehicle tasks at the discretion of the edge devices that are contained within the subsystems 202. Although not illustrated in FIG. 2, the subsystems 202 each execute a corresponding local state manager, such as the local state managers 116.

A subsystem 202-1 is a propulsion system or motion system. Motor/engine devices 216 of the subsystem 202-1 represent edge devices managed by the control system 204 to command vehicle propulsion units (e.g., an engine, a motor) to execute driving functions of the vehicle 102 (e.g., forward motion, reverse motion, acceleration, deceleration). In one or more examples, the motor/engine devices 216 manages operations of an engine of the vehicle 102, including fuel injection, ignition timing, emissions control, and engine health monitoring. In at least one aspect (e.g., in context of electric vehicles), the motor/engine devices 216 control inverters and motors that convert electric energy into mechanical energy for applying torque to wheels.

In addition, the subsystem 202-1 includes gearbox devices 218. Also referred to as a powertrain control module (PCM) and/or a transmission control module (TCM), transmission and gearbox functions are overseen by the gearbox devices 218 to implement an automatic transmission, optimize gear changes (e.g., gear shifts), and control torque delivered to the wheels of the vehicle 102. A vehicle may include one or more instances of the subsystem 202-1 (e.g., one subsystem 202-1 for each axle).

A subsystem 202-2 is a human machine interface (HMI) subsystem. The subsystem 202-2 includes one or more HMI control devices 220 that implement a vehicle user interface. The vehicle user interface enables interaction between occupants (e.g., driver, passenger) of the vehicle 102 and the vehicle system 200, which enables human intervention in vehicle functions and driving. For example, the HMI control devices 220 control vehicle displays, vehicle dash clusters, head-up display units, haptic feedback, audible feedback, and other visual driving aids interpreted by the occupants to help with driving or ensuring safe vehicle operations. In one or more implementations, the HMI control devices 220 provide a human-interface to effect climate controls (e.g., heating, cooling), cabin features (e.g., infotainment, lighting), and other vehicle body features (e.g., windshield wipers, transmission settings, suspension settings, drive mode selection, power seating, power mirrors, power door locks).

The subsystem 202-2 also includes one or more remote control devices 222 that allow human or machine inputs to control the vehicle 102 from outside the cabin. For example, in an autonomous or semi-autonomous vehicle context, the remote control devices 222 receive commands over a communication link with a base station (e.g., a mobile phone, a key fob, a remote computing system) to allow a human or machine operator to control the vehicle 102 as if the driving commands are provided directly to the HMI control devices 220. In hot or cold weather, to pre-cool or pre-heat the cabin, the remote control devices 222 activate remote starting functions. The remote control devices 222 in at least one aspect allow door locks to be unlocked or locked and doors, tailgates, or trunks to be remotely opened or closed.

A subsystem 202-3 represents a braking subsystem of the vehicle system 200. For example, one or more brake control devices 224 are operable to manage anti-lock braking systems (ABS), electronic stability controls (ESC), and otherwise convert driver inputs at the HMI control devices 220 to effect performance of vehicle brakes (e.g., for stopping, for decelerating). In some examples, the brake control devices 224 represent a braking control module (BCM).

Another of the subsystems 202 depicted in FIG. 2 includes a subsystem 202-4, which is an onboard-vehicle communication subsystem. The subsystem 202-4 manages telematics and communications that occur within the vehicle 102, and with other devices located outside the vehicle 102. For example, the subsystem 202-4 interfaces with the various edge devices coupled to the network 206 to ensure healthy exchange of data that is free of errors or faults. In addition, the subsystem 202-4 interfaces with other vehicles, mobile devices, infrastructure, and remote computing systems to implement various vehicle functions. One or more network control devices 228 of the subsystem 202-4 monitor network health of the network 206 and facilitate communication protocols implemented therein. The network control devices 228 are configured to diagnose problems with the network 206 to reroute signals and prevent data loss.

One or more telematic devices 226 of the subsystem 202-4 handle offboard communications of the vehicle 102. This includes implementing vehicle-to-vehicle (V2V) and vehicle-to-everything (V2X) communications that enable the vehicle 102 to communicate with other intelligent vehicles and systems in an operating environment (e.g., on or near a roadway). The telematic devices 226 interface with over-the-air (OTA) update services to update software on the vehicle 102. In addition, the telematic devices 226 interface with a positioning system to assist with navigation functions. Other features implemented by the telematic devices 226 include remote diagnostics, remote observation of environment via sensors such as cameras, radar or LIDAR, remote operations such as driving, and interfacing with emergency response services (e.g., to automatically alert emergency responders in the event of an accident).

A subsystem 202-5 is a drive subsystem of the vehicle system 200 for providing autonomous or semi-autonomous motion control, such as an advanced driving and safety (ADAS) subsystem. The subsystem 202-5 has two main functions, including implementing an ADAS as well as a perception sensor system. For example, one or more ADAS control devices 230 implement ADAS functionality that includes autonomous or semi-autonomous control, adaptive cruise control, emergency braking, lane centering, and other ADAS functions. One or more perception sensor devices 232 support the ADAS control devices 230 by providing information about the driving environment to ensure safe driving. For example, a radar, a camera, a lidar, an ultrasonic sensor, a global position system (GPS) sensor, an inertial measurement unit (IMU), and other sensor technology is deployed by the perception sensor devices 232 to collect sensor data about a vehicle environment. Sensor fusion techniques, object detection, lane centering, path trajectory planning, and other perception sensor functions are executed by the perception sensor devices 232 to enable the ADAS functions performed by the ADAS control devices 230.

A subsystem 202-6 is a steering subsystem that controls elements of the vehicle, which steer the wheels. One or more steer control devices 234 integrate with an electric power steering system of the vehicle 102 to control direction of the vehicle wheels. The steer control devices 234 receive inputs from the HMI control devices 220 and/or the control system 204, which are translated into appropriate steering commands for controlling steering actuators that change the direction of the wheels for steering and performing evasive maneuvers.

A subsystem 202-7 represents a body control subsystem of the vehicle 102. Included in the subsystem 202-7 are one or more body control devices 236, which oversee functions related to vehicle body controls. For example, window actuators, door locks and latches, interior and exterior lighting, tailgate and trunk latches, and the like are controlled by the body control devices 236 at the command of the control system 204 and/or one or more of the other subsystems 202 (e.g., the HMI control devices 220).

A subsystem 202-8 is an active suspension control subsystem. One or more suspension control devices 238 implement functions of a suspension control module (SCM) to regulate suspension components to adjust a ride level of the vehicle 102. For example, the suspension control devices 238 configure a vehicle suspension to be stiffer on paved surfaces for improved driving performance and maneuverability. In an offroad setting, the suspension control devices 238 enable a softer suspension setting to provide a smoother ride.

A subsystem 202-9 represents a battery management subsystem of the vehicle 102. One or more battery management devices 240 monitor and manage the continuity of energy supply and performance of a battery pack (also referred to as a traction battery) to ensure appropriate energy supply and charging and discharging rates to promote longevity and overall battery health. The battery management devices 240 control charging operations of on board vehicle batteries as well as controlling battery usage (e.g., to control a rate of discharge). The battery management devices 240 monitor health of vehicle batteries to alert the control system 204 when a malfunction is imminent or occurring.

Finally, a subsystem 202-N is depicted in FIG. 2, which represents a power distribution system. One or more power distribution devices 242 of the subsystem 202-N manage the distribution of electrical power from energy sources on the vehicle 102 to the vehicle system 200. For example, the power distribution devices 242 control power switches, inverters, converters, and other electrical distribution components to ensure the subsystems 202 receive an appropriate level of current and voltage for implementing vehicle functions. The power distribution devices 242 can include fault protection circuits and breakers to interrupt power to a faulty subsystem and maintain safe electrical conditions while the vehicle 102 remains active. The power distribution devices 242 interface with the motor/engine devices 216 and the battery management devices 240 to manage safe electrical conditions throughout the vehicle system 200.

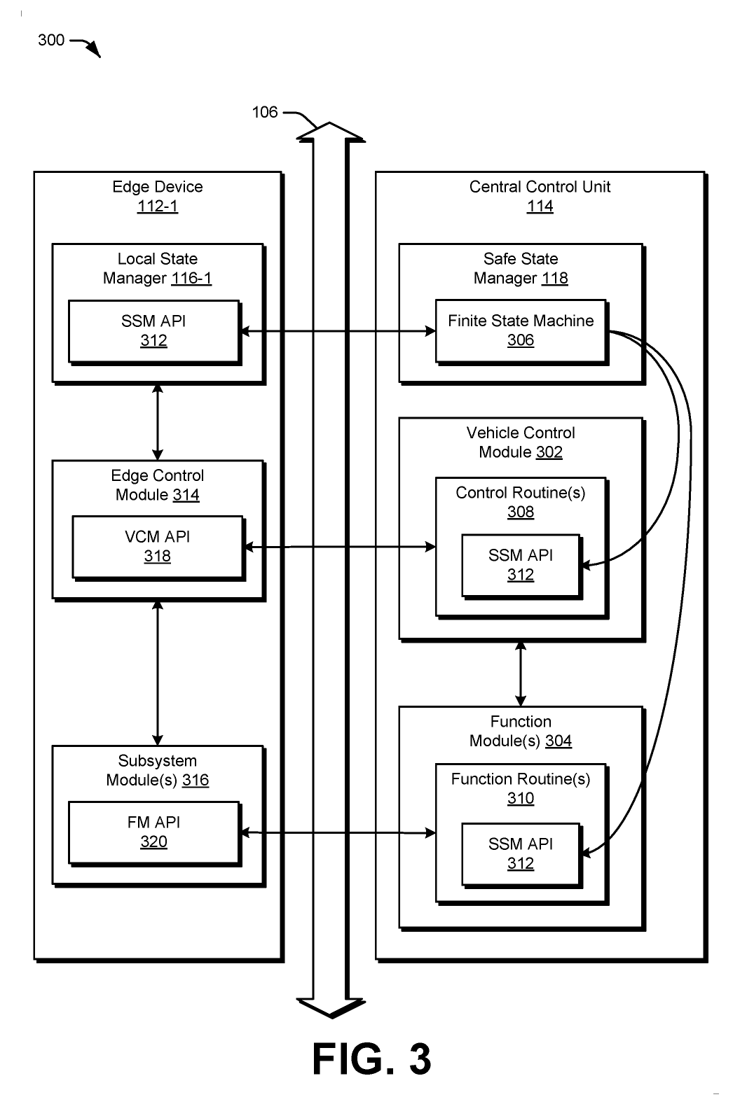

FIG. 3 is a block diagram of a non-limiting example of a vehicle system 300 that implements safe state management for autonomous operations. The vehicle system 300 is an example of the vehicle system 104 and the vehicle system 200. For ease of description, the vehicle system 300 is described in the context of the vehicle system 104 of FIG. 1.

The vehicle system 300 includes the central control unit 114, which is operatively and communicatively coupled to the edge device 112-1 over one or more connections established via the vehicle network 106. In the depicted example of FIG. 3, the safe state manager 118 represents a first software module that executes on the central control unit 114 separate from a plurality of second software modules executing on the central control unit 114. For example, the safe state manager 118, in one or more implementations, is a single thread and each of the second software modules is executed by the central control unit 114 as additional, separate threads. The safe state manager 118 is executed apart from the other second software modules to enable inspection for auditing as well as to ensure the second software modules do not diminish performance or interfere with operations of the safe state manager 118 in providing ASIL-D compliance and for achieving SAE Level 4 autonomy.

As one real-world example, the autonomous vehicle 102’s braking system may experience a catastrophic failure. If a pedestrian is detected in the vehicle 102’s path, the safe state manager 118 ensures that the forward momentum (e.g., kinetic energy) of the vehicle 102 is eliminated as quickly as possible. The safe state manager 118 transitions the vehicle into a global safety state that overrides normal operations of the subsystems 108 to prevent an accident.

As depicted in FIG. 3, the second software modules include a vehicle control module 302 that executes one or more control routines 308 for driving the autonomous vehicle 102. The control routines 308 issue commands to the edge devices 112 including the edge device 112-1 that implement vehicle operations (e.g., acceleration, stopping, steering) utilizing the subsystems 108-1. The second software modules also include one or more function modules 304 that execute functional routines 310 utilizing the subsystems 108 of the autonomous vehicle 102. For example, the function modules 304 implement autonomous driving functions by communicating with the control routines 308 to effect subsystem functions performed by the various subsystems 108.

In a complex urban environment with traffic lights, pedestrians, and other vehicles, the vehicle control module 302 executes the control routines 308 to navigate the environment 100. If one or more of the vehicle subsystems 108 fail, such as a sensor misreading a traffic light, the safe state manager 118 receives an indication of the failure in the health data 120-1. If the issue persists and is not mitigatable by the edge device 112-1, the finite state machine 306 triggers a predetermined vehicle response, such as slowing down the vehicle 102 and safely pulling it over to the side of the road.

In one or more other examples, the safe state manager 118 is implemented at least partially in hardware of the central control unit 114. For instance, the safe state manager 118 includes a specialized hardware block (e.g., an IPU) within the central control unit 114 that is separate from a processor of the central control unit 114. The processor may execute the plurality of software modules including at least one of the vehicle control module 302 or the one or more function modules 304, independent from execution of the safe state manager 118 occurring in the IPU (or separate processor of the central control unit 114).

Whether implemented in hardware or software, the safe state manager 118 enables a safe state manager application program interface, which is labeled and referred to throughout as an SSM API 312. The SSM API 312 is configured to receive the health data 120 being communicated on the vehicle network 106 from the local state managers 116 executing at each of the edge devices 112. For example, the SSM API 312 is accessed by the control routines 308 and/or the function routines 310 to receive data being output from the safe state manager 118 and the finite state machine 306. As one example, the SSM API 312 is configured to output commands to one or more of the second software modules (e.g., the vehicle control module 302 and/or the function routines 310) that trigger the predetermined response based on the commands obtained from the SSM API 312.

In addition to the local state manager 116-1, the edge device 112-1 includes an edge control module 314 and one or more subsystem modules 316. The local state manager 116-1 accesses the SSM API 312 to provide inputs (e.g., the health data 120-1) to the finite state machine 306 to enable the safe state manager 118 to derive an appropriate global vehicle state of the vehicle 102. The edge control module 314 receives commands from the control routines 308 via a vehicle control module application program interface, which is labeled and referred to throughout as VCM API 318. The subsystem modules 316 receive commands from the function routines 310 via a function module application program interface, which is labeled and referred to throughout as FM API 320.

The local state manager 116-1 receives information from the edge control module 314 and/or the subsystem module 316 to monitor a current operational state of a corresponding subsystem (e.g., the subsystem 108-1) to trigger a predetermined subsystem response commanded by the edge control module 314, which attempts to locally mitigate a subsystem failure. When a subsystem failure persists in the reported health data 120-1 for a period of time, the finite state machine 306 commands the control routines 308 and the edge control module 314 to trigger the predetermined vehicle response derived by the finite state machine 306 to override the predetermined subsystem response triggered by the local state manager 116-1. For example, if the issue cannot be mitigated in the time it takes for the health data 120-1 to reach the finite state machine 306 and the predetermined response, then the predetermined response (defined by commands issued by the control routines 308) is allowed to override the local mitigation at the edge device 112-1. This way, the edge control module 314 is allowed to attempt to mitigate a subsystem failure reported by the subsystem modules 316 or detected by the edge control module 314. However, if the problem is unmitigable in a short amount of time, the central control unit 114 takes over to force the edge control module 314 to mitigate the issue using a global response solved by the finite state machine 306 for the whole vehicle system 300. The safe state manager 118 refrains from triggering the predetermined vehicle response for a period of time when the reported health data 120-1 indicates the subsystem failure is mitigatable by the predetermined subsystem response initiated by the edge device 112-1. This period of time represents, for instance, a Fault Tolerant Time Interval (FTTI). Adherence to the FFTI causes a holdoff of the escalation of the overall safety state of the vehicle 102, while a (potentially) mitigable fault is being handled.

In summary, the safe state manager 118 ensures safety of the vehicle 102 and enables a high level of autonomy by constantly monitoring the global safety state based on aggregating indications of subsystem health, to coordinate a predetermined vehicle response that includes mitigating subsystem failures and transitioning to a different global safety safe state when necessary to prevent injury or damage. The finite state machine 306 enables the autonomous vehicle 102 to perform a deterministic response to each possible subsystem failure and ensure the vehicle 102 operates safely and efficiently in real-world conditions. As used throughout this disclosure, the phrase “subsystem failure” encompasses failures that occur anywhere in the vehicle 102, including any type of fault that occurs internal or external to the central control unit 114, including any kind of fault happening within any combination of one or more of the vehicle subsystems 108.

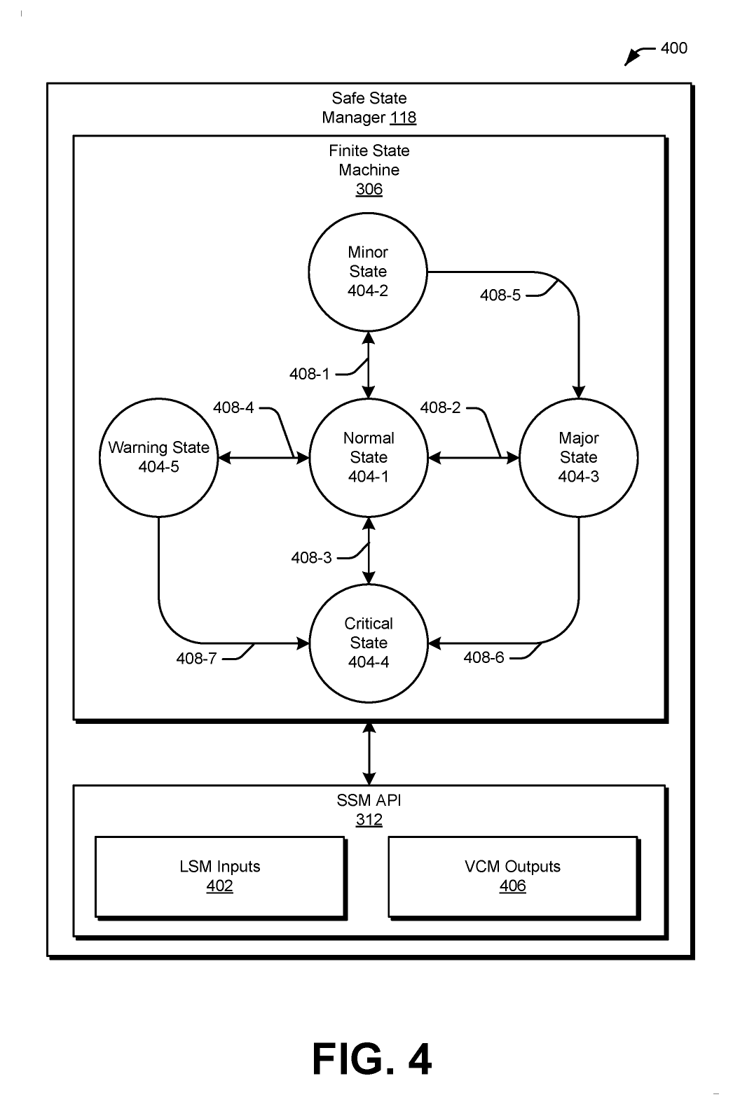

FIG. 4 is a block diagram of a non-limiting example of a vehicle system 400 that implements safe state management for autonomous operations. The vehicle system 400 is an example of the vehicle system 104, the vehicle system 200, and the vehicle system 300. For ease of description, the vehicle system 400 is described in the context of the vehicle system 104 of FIG. 1.

The vehicle system 400 includes the safe state manager 118, which depicts the finite state machine 306 and the SSM API 312 depicted in greater detail. The finite state machine 306 is configured to derive the global safety state of the vehicle 102 based on the reported health data 120 and trigger the predetermined vehicle response for the global safety state in response to subsystem failures.

The global safety state is selected based on a current state of the finite state machine 306. For example, the possible global safety states derived by the finite state machine 306 include a normal safety state 404-1, a minor safety state 404-2, a major safety state 404-3, a critical safety state 404-4, and a warning safety state 404-5.

The finite state machine 306 receives local state manager inputs (labeled as LSM inputs 402) through the SSM API 312. The health data 120 is an example of the LSM inputs 402. The safe state manager 118 is configured to receive the health data 120 being communicated on the vehicle network 106 from local state managers 116 executing at each of the edge devices 112 as the LSM inputs 402. Based on the LSM inputs 402, the finite state machine 306 transitions between the safety states 404-1 through 404-5. For example, a plurality of edges 408-1 through 408-7 connect the safety states 404-1 through 404-5. Depending on values or information contained in the LSM inputs 402, the finite state machine 306 transitions from one of the safety states 404-1 through 404-5 to another of the safety states 404-1 through 404-5 by traversing the appropriate edges 408-1 through 408-7.

The finite state machine 306 issues vehicle control module outputs (labeled as VCM outputs 406) through the SSM API 312. The safe state manager 118 is configured to output commands to one or more of the vehicle control module 302 and/or the function control module 304, which trigger the predetermined response across the edge devices 112 based on the commands. Coordinating the predetermined vehicle response across the edge devices 112 to maintain a safe operating envelope of the autonomous vehicle 102 during a subsystem failure is implemented by issuing the VCM outputs 406. Based on the current state of the finite state machine 306 being one of the safety states 404-1 through 404-5, the finite state machine 306 issues an appropriate predetermined response through the VCM outputs 406. Depending on values or information contained in the VCM outputs 406, the vehicle control module 302 causes the control routines 308 to execute the predetermined response for a current vehicle safety state by issuing commands through the SSM API 312 as the VCM outputs 406 to the edge control module 314. As another example, the function modules 304 cause the function routines 310 to execute the predetermined response for a current vehicle safety state by issuing commands through the SSM API 312 as the VCM outputs 406 to the subsystem modules 316.

In one or more aspects, the predetermined vehicle response for the minor safety state 404-2 causes the edge devices 112 to keep the subsystems 108 in a current operational state that maintains the safe operating envelope. For example, the finite state machine 306 transitions across the edge 408-1 from the normal state 404-1 to the minor state 404-2. In other words, the edge devices 112 are allowed to continue to operate as if no failure is occurring because the subsystem failure does not pose a serious risk to safety.

In one or more examples, the predetermined vehicle response for the major safety state 404-3 causes the edge devices 112 to transition the subsystems 108 from a current operational state to a minimum risk maneuver state. For example, the finite state machine 306 transitions across the edge 408-2 from the normal state 404-1 to the major state 404-3. The edge devices 112 may operate in a diminished mode (e.g., speed limited, steering angle limited, etc.) as if no immediate risk to safety is present, but possible if excessive speed or drastic (e.g., large steering angle) maneuvers are allowed.

The predetermined vehicle response for the critical safety state 404-4, for example, causes the edge devices 112 to transition the subsystems 108 from a current operational state to an emergency stop state. For example, the finite state machine 306 transitions across the edge 408-3 from the normal state 404-1 to the critical state 404-4. When the finite state machine 306 derives the critical safety state 404-4 based on the health data, the edge devices 112 receive commands from the vehicle control module 302 and/or the function modules 304 to take an immediate action that eliminates kinetic energy from the system.

In at least one implementation, the predetermined vehicle response for the warning safety state 404-5 causes the edge devices 112 to keep the subsystems in the current operational state until an additional subsystem failure is reported in the health data where the finite state machine 306 derives the global safety state to be the critical safety state 404-4. For example, to ensure that the finite state machine 306 operates in a deterministic way to handle each possible failure condition, the vehicle 102 operates in the warning safety state 404-5 when an unknown or new subsystem failure occurs. The finite state machine 306 transitions across the edge 408-4, for instance, from the normal state 404-1 to the warning state 404-5. As long as no other failures occur, the finite state machine 306 continues to monitor and wait to cause any disruption in vehicle operability. However, if a minor subsystem failure, major subsystem failure, or critical subsystem failure (or another undefined subsystem failure occurs), then the finite state machine 306 forces the vehicle 102 into the critical safety state 404-5. For example, the finite state machine 306 transitions across the edge 408-7 from the warning state 404-5 to the critical state 404-4 when an unusual or new potential subsystem failure is detected at the same time another known or unknown subsystem failure occurs.

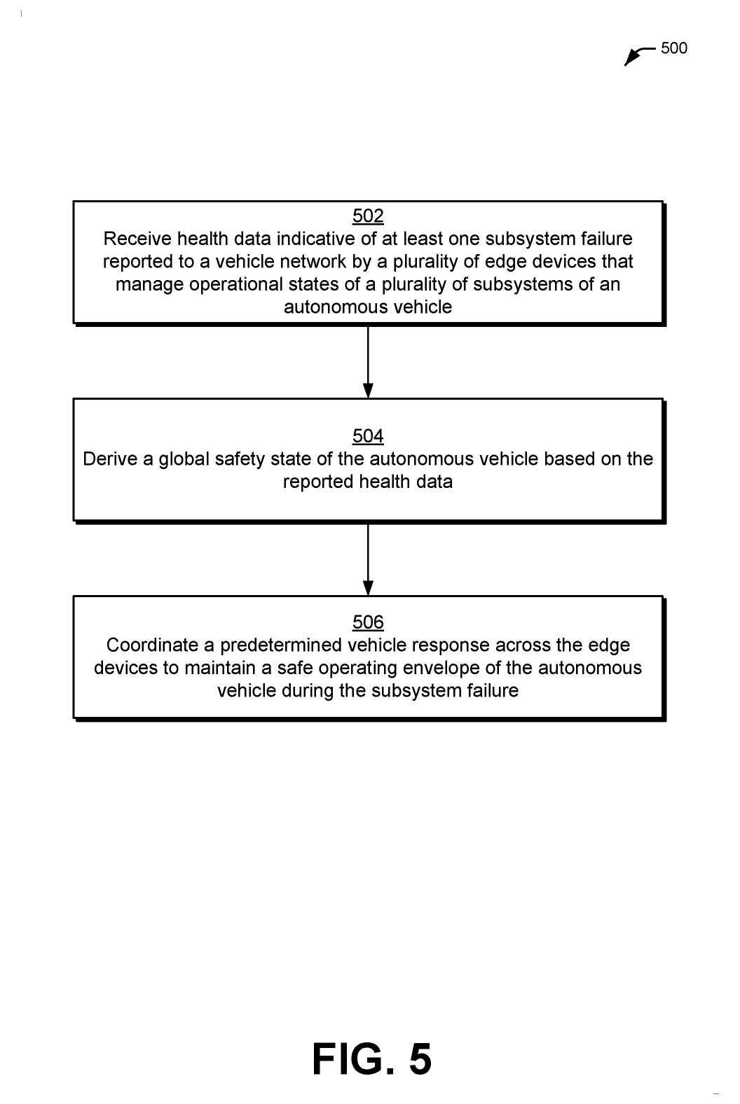

FIG. 5 depicts a flow chart of a non-limiting example of a procedure 500 for implementing safe state management for autonomous operations. The procedure 500 includes multiple operations illustrated as step 502 through step 506 and provides just one example procedure performed within any of the previously described systems (e.g., the vehicle system 104, the vehicle system 200, the vehicle system 300, the vehicle system 400). The procedure 500 is not limited to the order of steps shown in FIG. 5, other orderings of the step 502 through the step 506 are possible. In one or more implementations, the procedure 500 includes additional or fewer steps than those depicted in FIG. 5.

At the step 502, the procedure 500 starts with receiving health data indicative of at least one subsystem failure and reported to a vehicle network by a plurality of edge devices that manage operational states of a plurality of subsystems of an autonomous vehicle. For example, the central control unit 114 executes the safe state manager 118, which obtains the health data 120-1 reported to the vehicle network 106 from the edge device 112-1. The health data 120-1 indicates a subsystem failure associated with the vehicle subsystem 108-1, which in one or more examples is a hardware failure, a software failure, or a combination of hardware and software failures.

The procedure continues with the step 504, which includes deriving a global safety state of the autonomous vehicle based on the reported health data. For example, the safe state manager 118 executes the finite state machine 306 that transitions from the normal state 404-1 to the major state 404-3 based on the health data 120-1 being received as one or more of the LSM inputs 402. Upon receipt of the health data 120-1 via the SSM API 312, the finite state machine 306 immediately transitions the vehicle 102 into the major state 404-3 because the health data 120-1 indicates a major failure with a braking controller that represents a risk to safety and risk to preserving the safe operating envelope of the vehicle 102 when driving.

The procedure concludes with the step 506, which includes coordinating a predetermined vehicle response across the edge devices to maintain a safe operating envelope of the autonomous vehicle during the subsystem failure. For example, the finite state machine 306 outputs a command or signal to the VCM outputs 406 of the SSM API 312 that causes the central control unit 114 to transition each of the edge devices 112 into the major state 404-3. Upon receipt of the command or signal to the VCM outputs 406 of the SSM API 312, the control routines 308 issue communications over the vehicle network 106 that trigger the edge devices 112 to perform a minimum risk maneuver by immediately pulling over and relying on a reverse motor control or redundant braking system to bring the vehicle 102 to a controlled stop. Had the health data 120-1 caused the finite state machine 306 to transition from the normal state 404-1 to the critical state 404-4 (e.g., if all braking systems are inoperable and forward momentum is reduced through reverse motor controls alone), the control routines 308 may issue communications over the vehicle network 106 that trigger the edge devices 112 to perform an emergency stop without pulling out of the way of traffic because doing so is safer overall then trying to continue to drive to a safe stopping location. In this way, the finite state machine 306 enables the vehicle 102 to operate safely under each possible safety risk condition to satisfy ASIL-D compliance and achieve SAE Level 4 autonomy.

Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the subsystems 108, the edge devices 112, the central control unit 114, the local state managers 116, the safe state manager 118, the subsystems 202, the control system 204, the vehicle control module 302, the function modules 304, the edge control modules 314, and the subsystem modules 316) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a DSP, a GPU, a parallel accelerated processor, a plurality of microprocessors, one or more microprocessors in association with a DSP core, a controller, a microcontroller, Application Specific Integrated Circuits (ASICs), FPGAs, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a ROM, a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a vehicle network that communicatively couples a plurality of subsystems of an autonomous vehicle;
a plurality of edge devices that manage operational states of the subsystems to report health data to the vehicle network indicative of at least one subsystem failure; and
a central control unit that manages a global safety state of the autonomous vehicle based on the reported health data and coordinates a predetermined vehicle response across the edge devices to maintain a safe operating envelope of the autonomous vehicle during the subsystem failure.

2. The system of claim 1, wherein the central control unit implements a safe state manager that uses a finite state machine to derive the global safety state based on the reported health data and trigger the predetermined vehicle response for the global safety state in response to the subsystem failure.

3. The system of claim 2, wherein the global safety state is selected from one or more of a warning safety state, a minor safety state, a major safety state, or a critical safety state.

4. The system of claim 3, wherein the predetermined vehicle response for the minor safety state causes the edge devices to keep the subsystems in a current operational state that maintains the safe operating envelope.

5. The system of claim 3, wherein the predetermined vehicle response for the major safety state causes the edge devices to transition the subsystems from a current operational state to a minimum risk maneuver state.

6. The system of claim 3, wherein the predetermined vehicle response for the critical safety state causes the edge devices to transition the subsystems from a current operational state to an emergency stop state.

7. The system of claim 6, wherein the predetermined vehicle response for the warning safety state causes the edge devices to keep the subsystems in the current operational state until an additional subsystem failure is reported in the health data where the finite state machine derives the global safety state to be the critical safety state.

8. The system of claim 2, wherein each of the edge devices implements a local state manager that monitors a current operational state of a corresponding subsystem to trigger a predetermined subsystem response that attempts to locally mitigate the subsystem failure.

9. The system of claim 8, wherein the predetermined vehicle response triggered by the safe state manager overrides the predetermined subsystem response triggered by the local state manager when the subsystem failure persists in the reported health data for a period of time.

10. The system of claim 8, wherein the safe state manager refrains from triggering the predetermined vehicle response for a period of time when the reported health data indicates the subsystem failure is mitigatable by the predetermined subsystem response.

11. The system of claim 2, wherein the safe state manager comprises a first software module that executes on the central control unit separate from a plurality of second software modules executing on the central control unit.

12. The system of claim 11, wherein the plurality of second software modules includes a vehicle control module that executes one or more control routines for the autonomous vehicle.

13. The system of claim 12, wherein the one or more control routines generate commands for utilizing the subsystems of the autonomous vehicle.

14. The system of claim 11, wherein the first software module enables an application program interface configured to receive the health data being communicated on the vehicle network from local state managers executing at each of the edge devices.

15. The system of claim 11, wherein the first software module enables an application program interface configured to output commands to one or more of the plurality of second software modules that trigger the predetermined response based on the commands.

16. The system of claim 2, wherein the safe state manager comprises a first hardware block within the central control unit that is separate from a processor of the central control unit that executes a plurality of software modules including at least one vehicle control module.

17. A method comprising:
receiving, by a central control unit of an autonomous vehicle, health data indicative of at least one subsystem failure reported to a vehicle network by a plurality of edge devices that manage operational states of a plurality of subsystems of the autonomous vehicle;
deriving, by the central control unit, a global safety state of the autonomous vehicle based on the reported health data; and
coordinating, by the central control unit, a predetermined vehicle response across the edge devices to maintain a safe operating envelope of the autonomous vehicle during the subsystem failure.

18. A computer-readable storage medium comprising instructions that, when executed, causes at least one processor of a central control unit of an autonomous vehicle to:
receive health data reported to a vehicle network by a plurality of edge devices that manage operational state of a plurality of subsystems of vehicle, the health data indicative of at least one subsystem failure;
derive a global safety state of the autonomous vehicle based on the reported health data; and
coordinate a predetermined vehicle response across the edge devices to maintain a safe operating envelope of the autonomous vehicle during the subsystem failure.

19. The computer-readable storage medium of claim 18, wherein the instructions, when executed, cause the at least one processor to derive the global safety state using a safe state manager that executes a finite state machine to derive the global safety state based on the reported health data and trigger the predetermined vehicle response for the global safety state in response to the subsystem failure.

20. The computer-readable storage medium of claim 19,
wherein the safe state manager comprises a first software module that executes on the at least one processor separate from a plurality of second software modules executing on the at least one processor; and
wherein at least one of:
the first software module enables an application program interface configured to receive the health data being communicated on the vehicle network from local state managers executing at each of the edge devices; or
the first software module enables an application program interface configured to output commands to one or more of the plurality of second software modules that trigger the predetermined response based on the commands.
